(19) United States
(12) Patent Application Publication
(10) Pub. No.: US 2019/0366984 A1
(43) Pub. Date: Dec. 5, 2019

(54) AXLE LIFTING DEVICE

(71) Applicants: Hermanus Johannes PIETERSE, Centurion (ZA); Stephan BEZUIDENHOUT, CENTURION (ZA)

(72) Inventor: Hermanus Johannes PIETERSE, Centurion (ZA)

(73) Assignee: Stephan BEZUIDENHOUT, CENTURION (ZA)

(21) Appl. No.: 16/480,175

(22) PCT Filed: Jan. 25, 2018
(86) PCT No.: PCT/IB2018/050442

§ 371 Date: Jul. 23, 2019

(30) Foreign Application Priority Data
Jan. 25, 2017 (ZA) 2016/6282

(51) Int. Cl. B60S 9/04; B66F 3/00; B66F 3/36; B66F 7/22; B62D 63/08; B60D 1/66

(52) U.S. Cl. CPC B60S 9/04; B66F 3/005; B66F 3/36; B60G 2200/4622; B62D 63/08; B60D 1/665; B66F 7/22

(57) ABSTRACT

The invention relates to an axle lifting device comprising a load bearing support body; a base portion proximate a lower end of the support body, wherein an upwardly curved portion extends from the base portion, the upwardly curved portion including a plurality stepped formations for frictionally engaging the ground; and an axle seat proximate an upper end of the support body, to support or accommodate the axle of the vehicle or trailer, wherein the axle lifting device can rotate on the curved portion between a lowered position and a lifted position, wherein the axle seat extends substantially upright with respect to the ground with the base portion engaging the ground, for lifting the axle off the ground, with the stepped formations functionally and sequentially engaging the ground as the axle lifting device moves between the lowered and lifted positions

### FIELD OF INVENTION

THIS INVENTION relates to an axle lifting device, and in particular to a combination jack and axle-stand. The invention extends to an axle lifting assembly, and to a method of lifting an axle of a vehicle or trailer.

The invention is expected to be particularly advantageously applicable to the lifting and lowering of heavy trailers in the commercial trucking industry. Accordingly, such applications should particularly, but not exclusively, be borne in mind when considering this specification.

### BACKGROUND OF INVENTION

A jack is used to lift and lower heavy-load truck trailers that require repairs, for example to their wheel brake linings or bearings. Generally, lifting a truck trailer involves placing a jack under an axle or chassis of the trailer and mechanically or hydraulically raising a load-bearing arm of the jack against the axle to lift the trailer.

Typically, a truck trailer would include a number of wheel and axle sets which are non-driven. When only a single jack is available, lifting the trailer for working on more than one wheel involves successively raising the axle sets or single wheels at their outboard ends, whilst also having to support the chassis at other points by employing stands such as trestles or wooden blocks.

A recent advance in the field has seen the use of a combined axle stand and lifting device that uses the drive motion of the tractor to elevate axle sets and concomitantly maintain their raised positions. The combined device is prone to slip or topple under load in use, and the present invention aims to reduce the risk of slippage or toppling.

### SUMMARY OF INVENTION

According to a first aspect of the invention there is provided an axle lifting device for lifting an axle of a vehicle or trailer, the device including:
a load bearing support body;
a base portion proximate a lower end of the support body, wherein an upwardly curved portion extends from the base portion, the upwardly curved portion including a plurality of distinct, spaced apart stepped formations for frictionally engaging the ground: and
an axle seat proximate an upper end of the support body, to support or accommodate the axle of the vehicle or trailer,
   wherein the axle lifting device can rotate on the curved portion between a lowered position, wherein the axle seat extends angularly with respect to the ground with the curved portion engaging the ground, to accommodate the axle while the vehicle or trailer is in a lowered, default position, and a lifted position, wherein the axle seat extends substantially upright with respect to the ground with the base portion engaging the ground, for lifting the axle off the ground, with the plurality of distinct, spaced apart stepped formations frictionally and sequentially engaging the ground as the axle lifting device moves between the lowered and lifted positions.

In an embodiment, the base portion is substantially flat and horizontally oriented on the ground when the axle lifting device is in the lifted position, with the combination of the base and curved portions defining a substantially continuous working base.

In an embodiment, the stepped formations are angularly spaced apart such that the stepped formation that is adjacent the base portion is at a lower height relative to the next immediately adjacent, upwardly stepped formation in the plurality of stepped formations.

In an embodiment, the device includes substantially flat, side support plates that extend from either side of the support body, with the area of the support plate proximate the curved portion being larger than the area of the support plate on the other side of the support body.

In an embodiment, the edges of the support plates include transversely extending skirts, with the skirt proximate the curved portion defining a kinked recess.

In an embodiment, the device includes a pair of gussets extend from the support body, the gusset pair comprising a pair of triangular gusset plates, which are arranged in a splayed V-shaped configuration, with a common seam of the gusset plates being secured to the support body.

In an embodiment, the device includes a gusset extending from the support plate proximate the curved portion, the gusset being located proximate the interface between the curved portion and the base portion, to receive a first of the stepped formations.

In an embodiment, friction pads are fitted to an underside of the base portion and each of the stepped formations, to operatively grip or frictionally engage the ground.

In an embodiment, the device includes a mounting formation extending from an end wall of the axle lifting device, opposite the upwardly curved portion.

In an embodiment, the axle seat comprises a curved cradle for operatively encircling at least a portion of the axle of the vehicle.

According to a second aspect of the invention there is provided an axle lifting assembly comprising:
an axle lifting device, of the type described above; and
a connector for operatively connecting the axle lifting device to a part of the vehicle or trailer to prevent slippage of the axle lifting device as the device moves between the lowered and lifted positions.

In an embodiment, the assembly includes a tensioner for operatively adjusting the tension of the connector.

In an embodiment, the connector includes one or more mounting means for mounting one end to the mounting formation on the axle lifting device and the other end to a leading wheel of the vehicle or trailer that is disposed ahead of the wheel on the axle that is lifted or to be lifted.

According to a second aspect of the invention there is provided a method of lifting an axle of a vehicle or trailer, the method comprising:
providing an axle lifting assembly of the type described above to lift the axle of a vehicle or trailer;
locating at least a portion of the axle that is to be lifted in the axle seat of the axle lifting device when the curved portion of the axle lifting device is engaged with the ground/road surface;
mounting the connector of the axle lifting assembly to a leading wheel of the vehicle or trailer; and
reversing the vehicle or trailer, or causing the vehicle or trailer to reverse, so that the connector is pulled forwardly by the reversing motion of the leading wheel of the vehicle or trailer so as to displace the axle lifting device between a lowered position, wherein the curved portion engages the ground, and a lifted position wherein the base portion of the axle lifting device engages the ground for supporting the axle in the lifted position.

In an embodiment, the mounting of the connector to the leading wheel of the trailer or vehicle may comprise locating the connector under the axle lifting device, preferably under the base portion, so that the connector remains sandwiched between the underside of the axle lifting device and the road surface, to assist with aligning the axle lifting device with the drive direction of the vehicle or trailer when the axle lifting device is displaced between the lowered and lifted positions.

In an embodiment, the connector of the axle lifting assembly wraps around the leading wheel of the vehicle or trailer, to assist in moving the axle lifting device between the lowered and lifted positions.

### BRIEF DESCRIPTION OF DRAWINGS

The invention will now be further described, by way of example, with reference to the accompanying diagrammatic drawings, in which:

FIG. 1 shows a top perspective view of an axle lifting device in accordance with the invention;

FIG. 2 shows a bottom perspective view of the axle lifting device of FIG. 1;

FIG. 3 shows a side view of the axle lifting device of FIG. 1 (with the opposite side view simply being a mirror image of this figure);

FIG. 4 shows a cross-sectional side view of a portion of the axle lifting device of FIGS. 1 and 2;

FIG. 5 shows a side view of a trailer in a lowered, default position, with the axle lifting device shown in FIGS. 1 to 4 being positioned behind a rear wheel of the trailer, ready to lift an axle of the trailer; and

FIG. 6 shows the trailer in FIG. 5 in a lifted position, after the trailer has reversed onto the axle lifting device of the invention.

### DETAILED DESCRIPTION OF AN EXAMPLE EMBODIMENT

The following description of the invention is provided as an enabling teaching of the invention. Those skilled in the relevant art will recognise that many changes can be made to the embodiment described, while still attaining the beneficial results of the present invention. It will also be apparent that some of the desired benefits of the present invention can be attained by selecting some of the features of the present invention without utilising other features. Accordingly, those skilled in the art will recognise that modifications and adaptations to the present invention are possible and can even be desirable in certain circumstances, and are a part of the present invention. Thus, the following description is provided as illustrative of the principles of the present invention and not a limitation thereof.

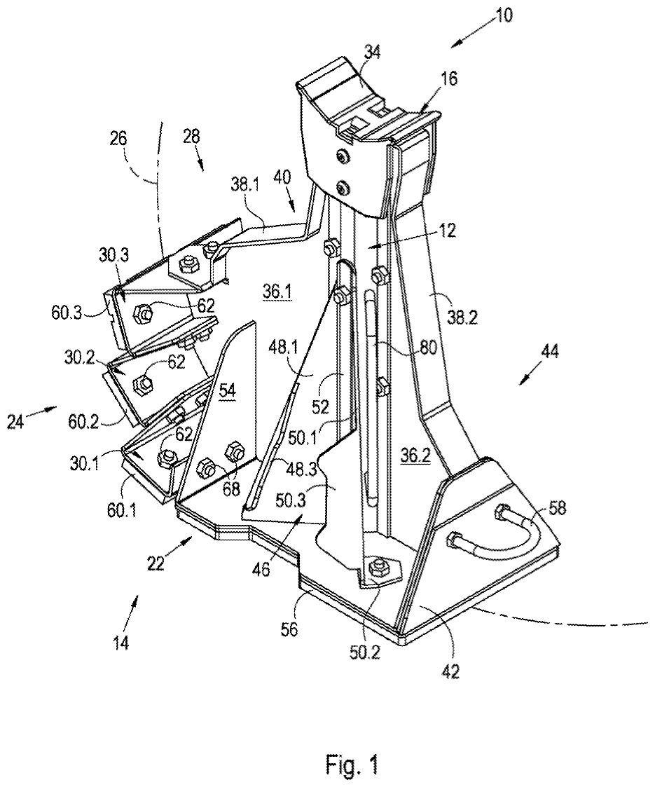

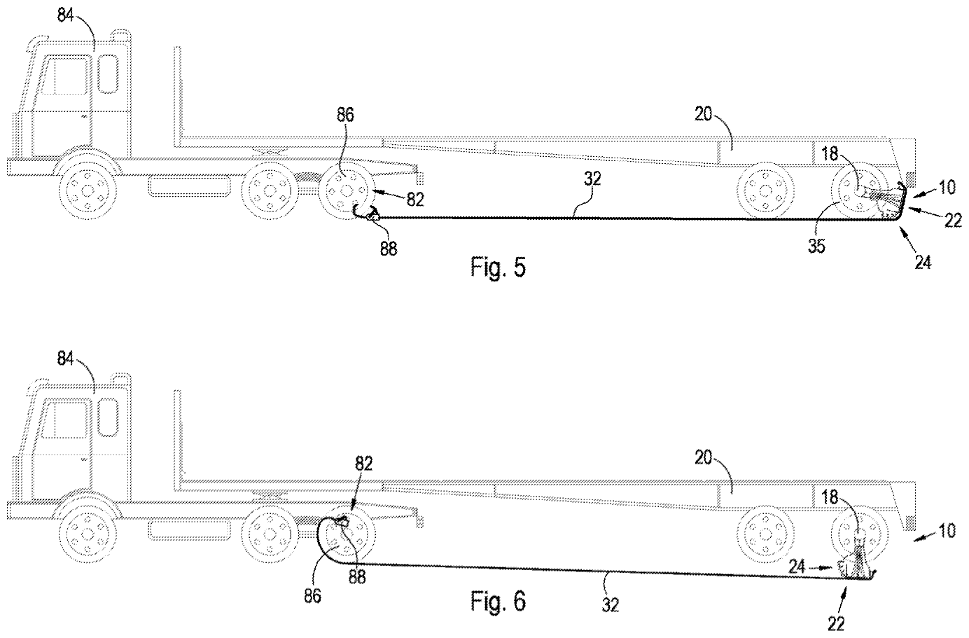

With reference to FIG. 1 of the drawings, reference numeral 10 denotes, generally, an axle lifting device that is typically a combination of a jack and axle-stand, according to one embodiment of the invention. The axle lifting device 10 includes a load bearing support body 12, a continuous working base 14 proximate a lower end of the support body 12, and an axle seat 16 proximate an upper end of the support body 12, to support or accommodate the axle 18 of a vehicle or trailer 20 (shown in FIGS. 5 and 6).

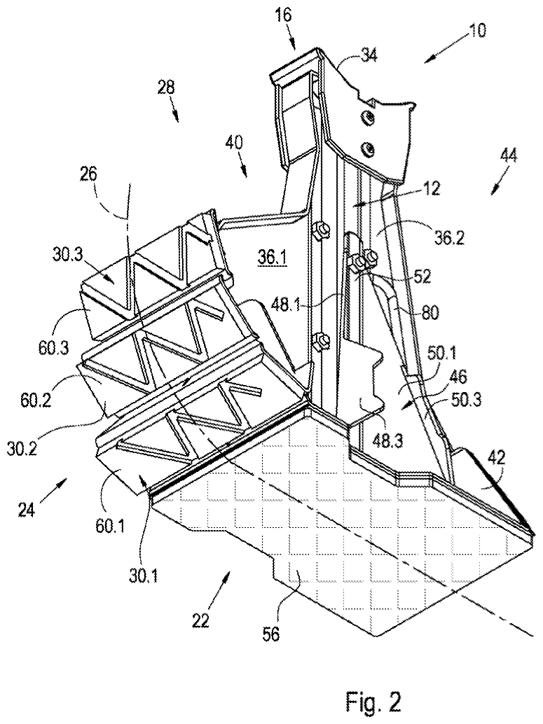

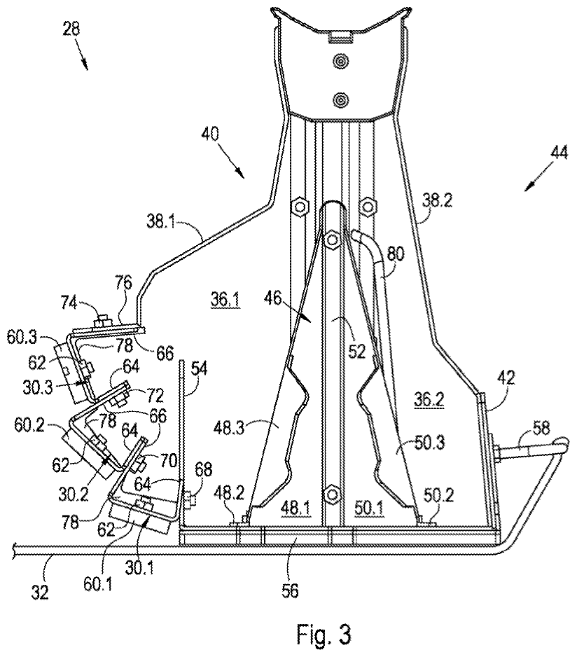

The working base 14 comprises a horizontal, substantially flat, rectangular base portion 22 and an upwardly curved portion 24 that is shaped substantially as a segment of a circle or arcuate curve (as best shown in FIG. 3) and as shown by curved line 26 in FIGS. 1 and 2. The support body 12 is positioned substantially in the middle of the flat base portion 22, with the curved portion 24 defining an operatively front end 28 of the device 10.

The curved portion 24 includes a plurality of (in this case, three) distinct, spaced apart, interconnected stepped formations 30.1, 30.2, 30.3. In use, each of the stepped formations 30.1, 30.2, 30.3 frictionally engages the ground, in a substantially sequential manner, as the axle lifting device 10 rotates, as will be described in more detail further below. As shown, the stepped formations are angularly spaced apart such that the stepped formation 30.1 that is adjacent the base portion 22 is at a lower height relative to the next immediately adjacent, upwardly stepped formation 30.2 in the plurality of stepped formations.

In particular, and with reference to FIGS. 5 and 6, the axle lifting device 10 rotates on the curved portion 24 between a lowered position, as shown in FIG. 5, and a lifted position, as shown in FIG. 6. The purpose of the connector 32 (typically a nylon strap) may be ignored for now, but will be described in more detail further below.

In the lowered position, the axle lifting device 10 is tilted to enable the axle seat 16 to engage or accommodate the axle 18; in this orientation, the curved portion 24 engages the ground. As the vehicle or trailer 20 reverses (i.e. moves to the right, with reference to FIGS. 6 and 6) towards the lifted position, the plurality of distinct, spaced apart stepped formations 30.1, 30.2, 30.3 frictionally and sequentially engage the ground. In the fully lifted position, as shown in FIG. 6, the support body 12 and axle seat 16 extends substantially upright with respect to the ground, with the base portion 22 arranged flat on the ground, so that the axle 18 is fully lifted off the ground.

The axle seal 16 typically takes the form of a cradle 34, to support or accommodate the axle 18 of the vehicle or trailer 20 to be lifted. The support body 12 may be vertically telescopically adjustable, if need be. In addition, the cradle 34 is removably secured to the support body 12, to enable it to be interchanged (in case another type of cradle is required for a particular application) or replaced (as a result of general wear and tear, for example).

The axle lifting device 10 includes a plurality of gussets or support plates, to reinforce and/or stabilise the axle lifting device 10 in use, as follows:
1. Substantially flat, side support plates 36.1 and 36.2 extend from either side of the support body 12. In view of the forces experienced by the axle lifting device 10 as it moves between the lowered and lifted positions, support plate 36.1 has a larger area than support plate 36.2. Also, the edges of the support plates 36.1, 36.2 are fitted with transversely extending skirts 38.1 and 38.2, respectively. Skirt 38.1 (and the relevant portion of the support plate 36.1) define a kinked recess 40, which enables the device 10 to be tilted to a relatively acute angle when the device 10 engages the axle 18 (as shown in FIG. 5); in other words, the kinked recess 40 ensures that the lifting device 10 (and in particular, the skirt 38.1) is clear from the ground as the device 10 rotates in use). The support plate 36.2 terminates at an upwardly extending end wall 42, proximate an operatively rear end 44 of the device 10.
2. Two pairs of gussets extend from the support body 12, to provide additional support, with only one gusset pair 46 being visible in FIGS. 1, 2, and 3 (the other gusset pair is provided behind the support body 12, and is thus not visible). The gusset pair 46 comprises a pair of triangular gusset plates 48.1, 50.1, which are arranged in a splayed V-shaped configuration (when viewed from above), with a common seam or edge 52 of the gusset plates 48.1, 50.1 being secured to the support body 12. Flanges 48.2, 50.2 extend from the bottom of each of the gusset plates 48.1, 50.1 as shown in FIGS. 1 and 3, respectively, to enable the gusset plates 48.1, 50.1 to be secured (bolted, typically) to the flat base portion 22. Inwardly turned ears 48.3, 50.3 extend from the lower region of each gusset plate 48.1, 50.1.
3. A further pair of gussets extend from either side of the support plate 36.1, to provide additional support, with only one gusset 54 being visible in FIGS. 1 and 3 in particular (the other gusset is provided behind the support plate 36.1, and is thus not shown). The gusset 54 is provided proximate the interface or juncture between the curved portion 24 and the base portion 22 and is used to secure the first of the stepped formations 30.1, as will be explained in more detail further below.

A friction pad 56 is fitted to the bottom of the base portion 22. Although not shown, the operatively underside of the friction pad 56 and/or the base portion 22 may define a guide or slot to receive or accommodate the nylon strap 32 mentioned above (and discussed in more detail further below).

The upwardly extending end wall 42, proximate the operatively rear end 44 of the device 10, is fitted with an attachment member or mounting formation 58. The attachment member 58 typically takes the form of a hook or rigid ring that extends from the external side of the end wall 42. In use, as shown in FIGS. 3, 5 and 6 of the drawings, an end of the nylon strap 32 may be attached or tied to the attachment member 58 and located under the operative underside of the base portion 22, thus sandwiching the strap 32 between the axle lifting device 10 and the ground.

Turning back to the stepped formations 30.1, 30.2, 30.3, as best shown in FIG. 3, the ends (i.e. operative undersides) of each stepped formation 30.1, 30.2, 30.3 is fitted with a friction pad 60.1, 60.2, 60.3, respectively, to provide better grip as the axle lifting device 10 moves between the lowered and lifted positions. The friction pads 60.1, 60.2, 60,3 are removably secured in place, typically with bolts 62, to enable the friction pads 60.1, 60.2, 60.3 to be replaced if/when needed.

Staying with FIG. 3, each stepped formation 30.1, 30.2, 30.3 comprises a substantially U-shaped bracket having short arms 64 and relatively longer arms 66 and a base portion 78 bridging each short arm 64 to each long arm 66. As can be seen in FIG. 3, the friction pads 60.1, 60.2, 60.3 are respectively fitted (i.e. bolted 62) below the base portions 78 of each stepped formation 30.1, 30.2, 30.3 respectively. As indicated above, stepped formation 30.1 is secured to the gusset 54; in particular, the short arm 64 of stepped formation 30.1 is bolted 68 to the gusset 54, as shown. In turn, the short arm 64 of stepped formation 30.2 is bolted 70 to the long arm 66 of stepped formation 30.1, and the short arm 64 of stepped formation 30.3 is bolted 72 to the long arm 66 of stepped formation 30.2. The long arm 66 of stepped formation 30.3 is bolted 74 to an end flange 76 of the skirt 38.1. The base portions 78 of each stepped formation 30.1, 30.2, 30.3, between the arms 64, 66, are clearly used to receive the friction pads 60.1, 60.2, 60.3 via the bolts 62.

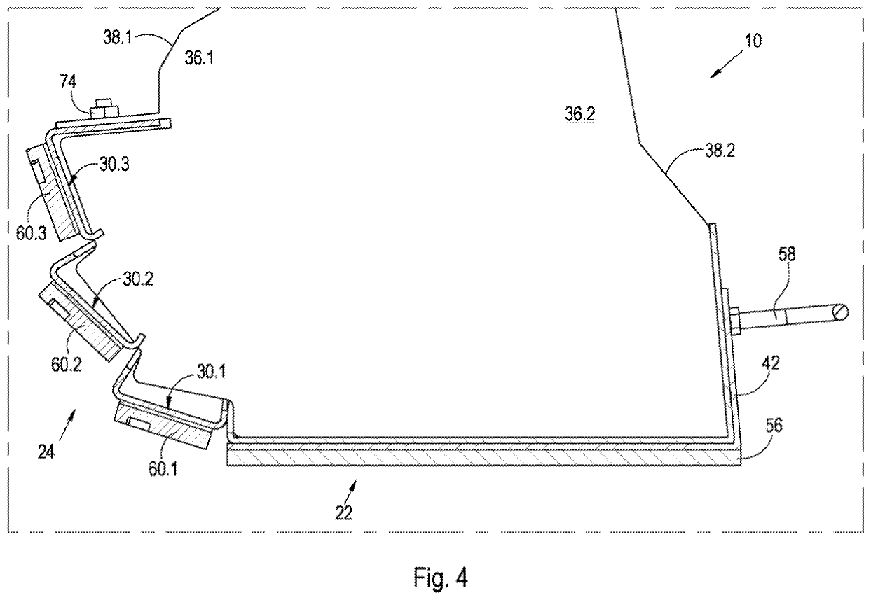

The axle lifting device 10 product has two primary uses or applications, the first being usage within a workshop environment and the second usage being out in the field e.g. roadside or on mines etc. The friction pads 60.1, 60.2, 60.3 shown more clearly in FIGS. 1 to 4 of the drawings are typically rubber pads, and are specifically for use on a workshop floor or tar surfaces. Without these rubber pads 60.1, 60.2, 60.3, the underlying stepped formations would be slippery, and would most likely damage the surface or ground on which the device 10 is operating.

Depending on the surface, the rubber pads 60.1, 60.2, 60.3 may be removed and replaced by plates covered with claws, spikes or any other gripping formation, as may be required in the case of mud or snow covered surfaces. The interchangeable/removed nature of the friction pads 60.1, 60.2. 60.3 is thus particularly advantageous, and allows the device 10 to operate on a variety of different road surfaces. In such a case, it may only be necessary to replace the first friction pad 60.1 on the first stepped formation 30.1, but this would depend on the relevant circumstances.

An elongate carrying handle 80 extends outwardly along the length of the load bearing support body 12 (typically on both sides of the support body 12).

Turning now to FIGS. 5 and 6, the axle lifting device 10 is shown in use, with a view to lifting the axle 18 of a trailer 20, as already indicated above. Before tilting the device 10 into place to enable the device 10 to engage the axle 18, the rear end of the nylon strap 32 is secured to the attachment member 58 and looped under, so as to be sandwiched by, the device 10 (as described above) so as to extend towards the front of the trailer 20.

As indicated above, the nylon strap 32 may extend through the guide or slot or recess defined under the device 10, to as to operatively align the axle lifting device 10 with the drive direction of the trailer/vehicle 20.

The front end of the strap 32 is secured to the lower end of a rear wheel 82 of a vehicle 84 pulling the trailer 20 and arranged immediately behind the wheel 82, so that, as the vehicle 84 reverses, the strap 32 wraps around the wheel 82 so as to define a pulley. The front end of the strap 32 is typically hooked onto the rim 86 of the rear wheel 82 of the vehicle 84.

A second axle lifting device 10 is fitted on the other side of the trailer 20 in a substantially similar manner. The straps 32 are fitted with ratchet tensioners 88 (one of which is visible in FIGS. 5 and 6), which may then be operated so as to tension the straps 32, typically after the device 10 has been titled so as to engage the axle 18 of the trailer 20 and after the front end of the strap 32 has been secured to the rim 86 of the rear wheel 82 of the vehicle 84. Since the front end of the strap 32 is secured to the lower end of the rear wheel 82, after being tensioned, the net result is the arrangement shown in FIG. 5, with the strap 32 running substantially flat along the ground.

The vehicle 84 to which the trailer 20 is connected, is reversed slowly over the straps 32, with the backward movement gradually elevating the axle 18 as the axle 18 engages the axle lifting devices 10. As described above, the axle lifting devices (of which one is shown as 10) rotate about their curved portions 24 towards their flat base portion 22. In conjunction with this movement, the wheels 82 of the vehicle 84 drive over the straps 32, with the straps 32 thus remaining anchored under the wheels 82. This causes the straps 32 to wrap around the outside of the wheels 82 of the vehicle 84, resulting in a pulley effect to assist in the controlled rotation of the devices 10. The straps 32 thus wind around the rear wheels 82 of the vehicle 84.

Once in the lifted position, as shown in FIG. 6, the axle lifting device 10 rests on the flat base portion 22, with the axle seat 16 being in a substantially upright position.

In order to lower the trailer 20, the above operation is simply reversed with the axle lifting devices 10 rotating back until the axle lifting devices 10 are supported on the ground/road surface via the curved portions 24.

1-10. (canceled)

11. An axle lifting assembly to lift an axle of a vehicle or trailer, the assembly including:
an axle lifting device including;
a load bearing support body;
a base portion proximate a lower end of the support body, wherein an upwardly curved portion extends from the base portion, wherein a mounting formation extends from an end wall of the axle lifting device, opposite the upwardly curved portion;
an axle seat proximate an upper end of the support body, to support or accommodate the axle of the vehicle or trailer, wherein the axle lifting device can rotate on the curved portion between a lowered position, wherein the axle seat extends angularly with respect to the ground with the curved portion engaging the ground, to accommodate the axle while the vehicle or trailer is in a lowered, default position, and a lifted position, wherein the axle seat extends substantially upright with respect to the ground with the base portion engaging the ground, for lifting the axle off the ground;
a connector for operatively connecting the axle lifting device to a part of the vehicle or trailer to prevent slippage of the axle lifting device as the device moves between the lowered and lifted positions; and
a tensioner for operatively adjusting the tension of the connector.

12. (canceled)

13. The axle lifting assembly according to claim 11, wherein the connector includes one or more mounting means for mounting one end to the mounting formation on the axle lifting device and the other end to a leading wheel of the vehicle or trailer that is disposed ahead of the wheel on the axle that is lifted or to be lifted.

14. A method of lifting an axle of a vehicle or trailer, the method comprising:
providing an axle lifting assembly to lift the axle of a vehicle or trailer, the assembly comprising:
an axle lifting device including:
a load bearing support body;
a base portion proximate a lower end of the support body, wherein an upwardly curved portion extends from the base portion;
an axle seat proximate an upper end of the support body, to support or accommodate the axle of the vehicle or trailer, wherein the axle lifting device can rotate on the curved portion between a lowered position, wherein the axle seat extends angularly with respect to the ground with the curved portion engaging the ground, to accommodate the axle while the vehicle or trailer is in a lowered, default position, and a lifted position, wherein the axle seat extends substantially upright with respect to the ground with the base portion engaging the ground, for lifting the axle off the ground; and
a connector for operatively connecting the axle lifting device to a part of the vehicle or trailer to prevent slippage of the axle lifting device as the device moves between the lowered and lifted positions;
locating at least a portion of the axle that is to be lifted in the axle seat of the axle lifting device when the curved portion of the axle lifting device is engaged with the ground/road surface;
mounting the connector of the axle lifting assembly to a leading wheel of the vehicle or trailer, so that the connector extends under the axle lifting device; and
reversing the vehicle or trailer, or causing the vehicle or trailer to reverse, so that the connector is pulled forwardly by the reversing motion of the leading wheel of the vehicle or trailer so as to displace the axle lifting device between the lowered position, wherein the curved portion engages the ground, and the lifted position wherein the base portion of the axle lifting device engages the ground for supporting the axle in the lifted position.

15. The method of claim 14, wherein the mounting of the connector to the leading wheel of the trailer or vehicle comprises locating the connector under the axle lifting device so that the connector remains sandwiched between the underside of the axle lifting device and the road surface, to assist with aligning the axle lifting device with the drive direction of the vehicle or trailer when the axle lifting device is displaced between the lowered and lifted positions.

16. The method of claim 14, wherein the connector of the axle lifting assembly wraps around the leading wheel of the vehicle or trailer, to assist in moving the axle lifting device between the lowered and lifted positions.

17. The axle lifting assembly according to claim 11, wherein the base portion is substantially flat and horizontally oriented on the ground when the axle lifting device is in the lifted position, with the combination of the base and curved portions define a substantially continuous working base.

18. The axle lifting assembly according to claim 11, wherein the upwardly curved portion includes a plurality of distinct, spaced apart stepped formations for frictionally engaging the ground, the plurality of distinct, spaced apart stepped formations frictionally and sequentially engaging the ground as the axle lifting device moves between the lowered and lifted positions.

19. The axle lifting assembly according to claim 18, wherein the stepped formations are angularly spaced apart such that the stepped formation that is adjacent the base portion is at a lower height relative to the next immediately adjacent, upwardly stepped formation in the plurality of stepped formations.

20. The axle lifting assembly according to claim 18, wherein the axle lifting device includes substantially flat, side support plates that extend from either side of the support body, with the area of the support plate proximate the curved portion being larger than the area of the support plate on the other side of the support body.

21. The axle lifting assembly according to claim 11, wherein the axle lifting device includes a pair of gussets extend from the support body, the gusset pair comprising a pair of triangular gusset plates, which are arranged in a splayed V-shaped configuration, with a common seam of the gusset plates being secured to the support body.

22. The axle lifting assembly according to claim 20, wherein the axle lifting device includes a gusset extending from the support plate proximate the curved portion, the gusset being located proximate the interface between the curved portion and the base portion, to receive a first of the stepped formations.

23. The axle lifting assembly according to claim 18, wherein friction pads are fitted to an underside of the base portion and each of the stepped formations, to operatively grip or frictionally engage the ground.

24. The axle lifting assembly according to claim 11, wherein the axle seat comprises a curved cradle for operatively encircling at least a portion of the axle of the vehicle.
